(19) United States
(12) Patent Application Publication
(10) Pub. No.: US 2026/0043270 A1
(43) Pub. Date: Feb. 12, 2026

(54) Tamper-Resistant Locking System and Method

(71) Applicant: Willo Products Company, LLC, Decatur, AL (US)

(72) Inventor: Brian S. Foss, Madison, AL (US)

(21) Appl. No.: 19/294,639

(22) Filed: Aug. 8, 2025

Related U.S. Application Data
(60) Provisional application No. 63/682,011, filed on Aug. 12, 2024.
(60) Provisional application No. 63/702,178, filed on Oct. 2, 2024.

(51) Int. Cl. E05B 17/20; E05B 9/00; E05B 9/04

(52) U.S. Cl. CPC E05B 17/2084; E05B 9/048; E05B 2009/004

(57) ABSTRACT

A lock system includes a cover, a lock assembly, and a baffle. The cover includes a first aperture defining a first cross-sectional dimension. The lock assembly includes a lock mechanism defining a second cross-sectional dimension. The baffle includes a base and at least one leg. The base includes a second aperture defining a third cross-sectional dimension smaller than the first cross-sectional dimension and larger than the second cross-sectional dimension. In an assembled configuration, the base engages the cover, the at least one leg engages the lock assembly, and the lock mechanism is disposed within the first aperture and the second aperture.

### CROSS-REFERENCE TO RELATED APPLICATIONS

This application claims the benefit of U.S. Provisional Application No. 63/682,011 filed Aug. 12, 2024 and U.S. Provisional Application No. 63/702,178 filed Oct. 2, 2024. The entire disclosures of the above applications are incorporated herein by reference.

### FIELD

This disclosure relates generally to a tamper-resistant lock assembly for a door, and more particularly to a lock assembly including a baffle for inhibiting the inclusion of debris in the lock assembly.

### BACKGROUND

This section provides background information related to the present disclosure and is not necessarily prior art.

Door locking assemblies are essential components for securing doors at prisons and various other properties and facilities. These assemblies are typically attached to the exterior side of a door, allowing authorized individuals to access a room (e.g., a prison cell) on the interior side of the door, and preventing unauthorized individuals from opening the door and exiting the room on the interior side of the door. The operation of these door locking assemblies can be compromised if the housing enclosing the locking system is compromised by depositing debris within the housing.

While known systems and methods for securing door locking systems may be acceptable for their intended purposes, there exists a continuous need in the pertinent art for an improved system and method for inhibiting tampering with a door locking system.

### SUMMARY

This section provides a general summary of the disclosure and is not a comprehensive disclosure of its full scope or all of its features.

One aspect of the disclosure provides a lock system. The lock system includes a cover, a lock assembly, and a baffle. The cover includes a first aperture defining a first cross-sectional dimension. The lock assembly includes a lock mechanism defining a second cross-sectional dimension. The baffle includes a base and at least one leg. The base includes a second aperture defining a third cross-sectional dimension smaller than the first cross-sectional dimension and larger than the second cross-sectional dimension. In an assembled configuration, the base engages the cover, the at least one leg engages the lock assembly, and the lock mechanism is disposed within the first aperture and the second aperture.

Another aspect of the disclosure provides a lock system. The lock system includes a lock assembly, a cover, and a baffle. The lock assembly includes a lock mechanism. The cover includes a first opening configured to receive the lock mechanism. The baffle includes a base and at least one leg. The base includes a first surface, a second surface, and a second opening smaller than the first opening and extending through the first surface and the second surface. The second opening is configured to movably receive the lock mechanism. The at least one leg extends from the first surface. In an assembled configuration, the second surface is configured to engage the cover, and the at least one leg is configured to engage the lock assembly.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The present disclosure will become more fully understood from the detailed description and the accompanying drawings.

FIG. 1 is a perspective view of a locking system in a closed orientation according to the principles of the present disclosure.

FIG. 2 is a perspective view of a baffle for a locking system according to the principles of the present disclosure.

FIG. 3 is a front view of a portion of a locking system including a lock mechanism and the baffle of FIG. 1 according to the principles of the present disclosure.

FIG. 4 is front view of a portion of a locking system including a lock mechanism and a cover according to the principles of the present disclosure.

FIG. 5 is a top schematic view of a locking system including a cover, a lock mechanism, and a baffle according to the principles of the present disclosure.

In the drawings, reference numbers may be reused to identify similar and/or identical elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

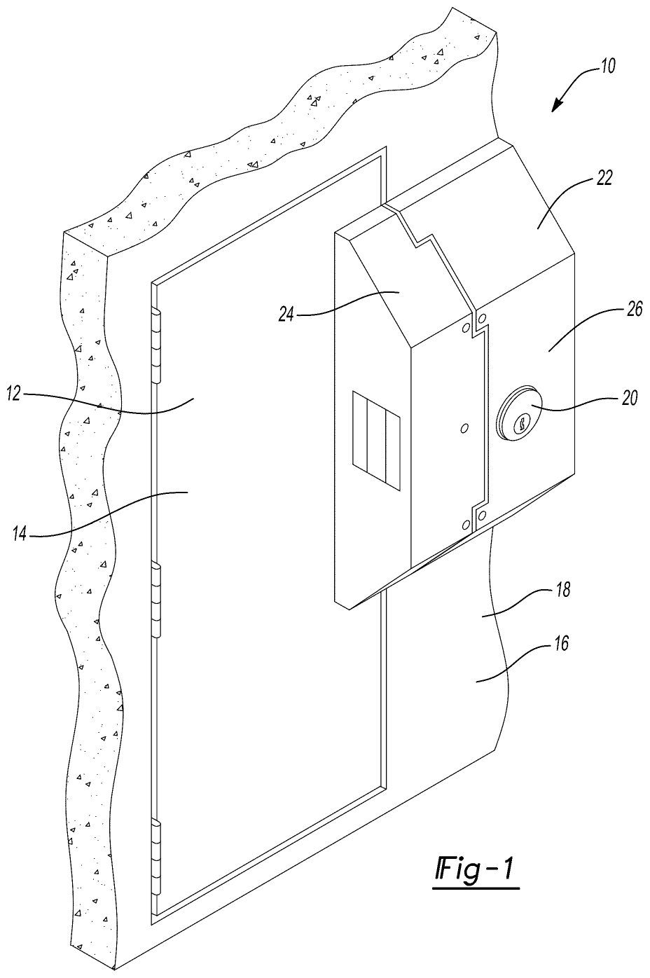

Referring to FIG. 1, a lock system 10 is illustrated. As will be explained in more detail below, the lock system 10 may be mounted on an exterior surface 12 of a door 14 and an exterior surface 16 of a wall 18 to secure the door 14 in a closed orientation (e.g., FIG. 1) relative to the wall 18.

With reference to FIGS. 1 and 3, the lock system 10 may include a lock assembly 20 (FIG. 3) that secures a position of a first housing assembly 22 of the lock system 10 relative to a second housing assembly 24 of the lock system 10. While the first housing assembly 22 is generally shown and described herein as being mounted on the wall 18, and the second housing assembly 24 is generally shown and described herein as being mounted on the door 14, it will be appreciated that the first housing assembly 22 may be mounted on the door 14, and the second housing assembly 24 may be mounted on the wall 18 within the scope of the present disclosure.

The first housing assembly 22 may include a cover 26, a baffle 28, and the lock assembly 20. The cover 26 may define an aperture 30 having a first cross-sectional dimension D1. In some configurations, the aperture 30 defines a circle such that the first cross-sectional dimension D1 is a diameter. As illustrated in FIG. 5, the cover 26 may include an inner surface 31.

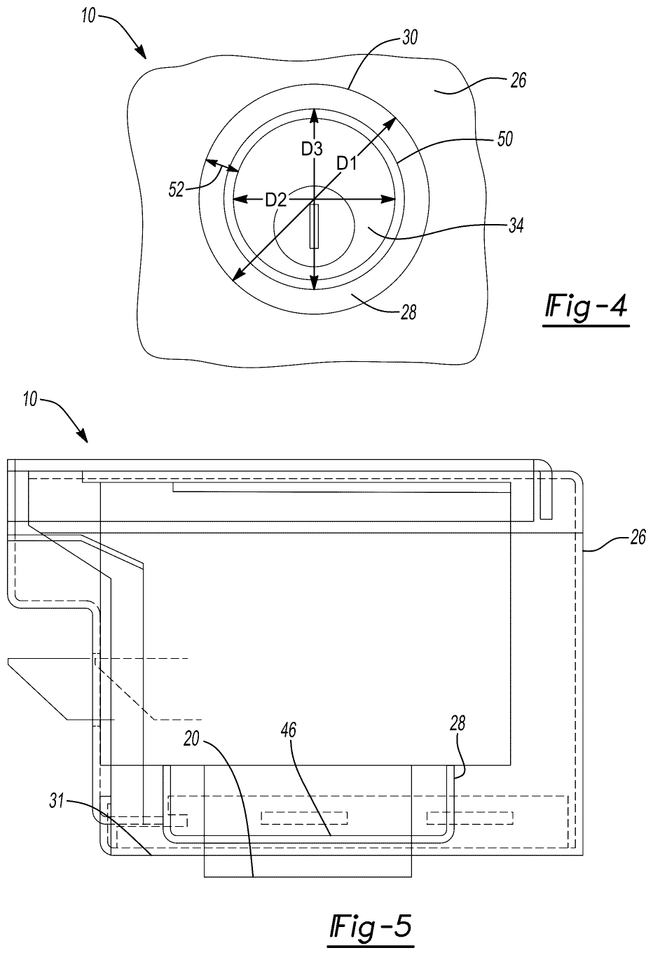

The lock assembly 20 may include a housing 32 and a lock mechanism 34 extending therefrom. The housing 32 may include an outer surface 33 facing the inner surface 31 of the cover 26. In some implementations, the lock mechanism 34 defines a second cross-sectional dimension D2. The second cross-sectional dimension D2 may be smaller than the first cross-sectional dimension D1. In some configurations, the lock mechanism 34 defines a circle such that the second cross-sectional dimension D2 is a diameter. In the assembled configuration (e.g., FIGS. 1, 4), the lock mechanism 34 may be disposed in the aperture 30 of the cover 26. In this regard, the aperture 30 is configured to movably receive the lock mechanism 34.

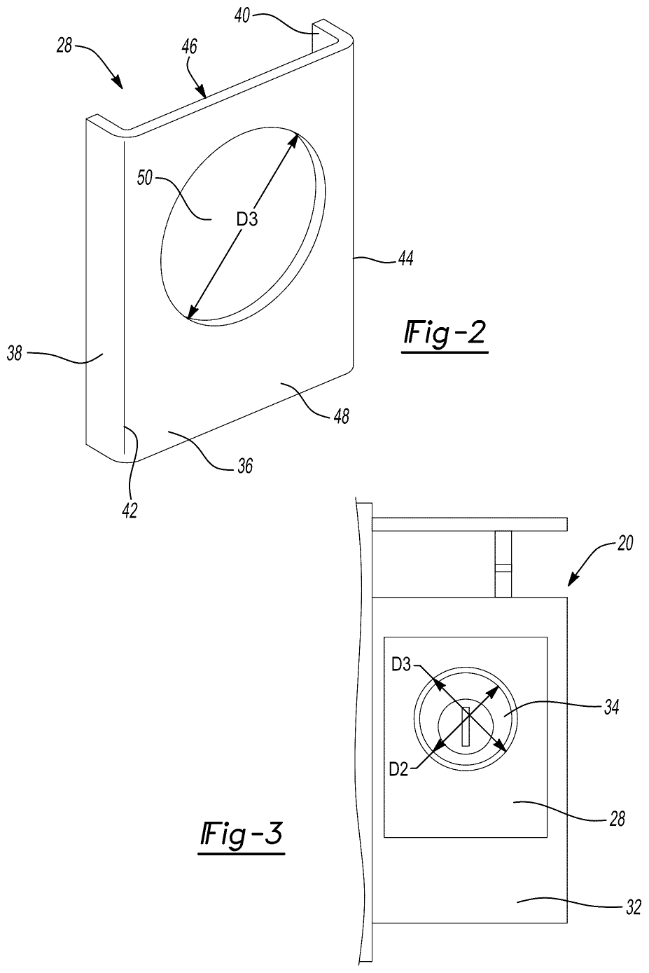

With reference to FIGS. 2, 3, and 5, the baffle 28 may include a base 36, a first leg 38, and a second leg 40. The first leg 38 and the second leg 40 may extend from the base 36. The first leg 38 may be disposed at and extend from a first end 42 of the base 36. The second leg 40 may be disposed at and extend from a second end 44 of the base 36. The first end 42 may be opposite the second end 44. The first leg 38 may be substantially (e.g., +/−20 degrees) parallel to the second leg 40. The base 36 may be substantially (e.g., +/−20 degrees) perpendicular to the first leg 38 and/or the second leg 40. In some implementations, a cross-section of the baffle 28 defines a U-shaped configuration.

The base 36 may include a first surface 46, a second surface 48 opposite the first surface 46, and an aperture 50 extending through the first surface 46 and the second surface 48. The aperture 50 may be disposed between the legs 38, 40 and define a third cross-sectional dimension D3. The third cross-sectional dimension D3 may be smaller than the first cross-sectional dimension D1 and larger than the second cross-sectional dimension D2. The third cross-sectional dimension D3 may be equal to or substantially (e.g., +/−one millimeter) equal to the second cross-sectional dimension D2. In some implementations, the aperture 50 is located at a center of the base 36. In some implementations, the aperture 50 defines a circle such that the third cross-sectional dimension D3 is a diameter. In the assembled configuration, the lock mechanism 34 may be disposed in the aperture 50 of the baffle 28. In this regard, the aperture 50 is configured to movably receive the lock mechanism 34.

In the assembled configuration, at least one leg (e.g., the first leg 38 and/or the second leg 40) of the baffle 28 may engage the lock assembly 20 (e.g., the outer surface 33), and the base 36 (e.g., the second surface 48) of the baffle 28 may engage the inner surface 31 of the cover 26. The baffle 28 may be movable (e.g., rotatable and/or translatable) relative to the lock mechanism 34 and the cover 26. In this regard, the baffle 28 may float between the lock assembly 20 and the cover 26 in the assembled configuration.

As illustrated in FIG. 4, in the assembled configuration, the cover 26 (e.g., the aperture 30) and the lock assembly 20 (e.g., the lock mechanism 34) may form a gap 52 in the first housing assembly 22. The baffle 28 (e.g., base 36 or the second surface 48) may at least partially block the gap 52. In some implementations, the baffle 28 completely blocks the gap 52.

In the assembled configuration, the configuration of the baffle 28, the cover 26, and the lock mechanism 34 can prevent a person (e.g., an inmate) from placing objects (e.g., debris) into the first housing assembly 22 through the gap 52 formed by the cover 26 and the lock assembly 20. In particular, (i) the engagement of the legs 38, 40 with the lock assembly 20, (ii) the engagement of the base 36 with the cover 26, and/or (iii) the relationship between the cross-sectional dimensions (e.g., D1, D2, and D3) of the lock mechanism 34, the aperture 30 in the cover 26, and the aperture 50 in the baffle 28 can inhibit the intrusion of debris into the first housing assembly 22 through the gap 52 formed between the cover 26 and the lock assembly 20.

The following Clauses provide an exemplary configuration for a lock system and method, as described above.

Clause 1: A lock system comprising: a cover including a first aperture defining a first cross-sectional dimension; a lock assembly including a lock mechanism defining a second cross-sectional dimension; and a baffle including a base and at least one leg, the base including a second aperture defining a third cross-sectional dimension smaller than the first cross-sectional dimension and larger than the second cross-sectional dimension, wherein, in an assembled configuration, the base engages the cover, the at least one leg engages the lock assembly, and the lock mechanism is disposed within the first aperture and the second aperture.

Clause 2: The lock system of clause 1, wherein the at least one leg includes a first leg engaging the lock assembly and a second leg engaging the lock assembly.

Clause 3: The lock system of any of clauses 1 through 2, wherein the second aperture is located between the first leg and the second leg.

Clause 4: The lock system of clause 3, wherein: the first leg extends from a first end of the base, and the second leg extends from a second end of the base.

Clause 5: The lock system of clause 4, wherein: the base is perpendicular to the first leg, and the first leg is parallel to the second leg.

Clause 6: The lock system of clause 5, wherein a cross-section of the baffle defines a U-shape.

Clause 7: The lock system of any of clauses 1 through 6, wherein the second aperture is located at a center of the base.

Clause 8: The lock system of any of clauses 1 through 7, wherein the second aperture defines a circle.

Clause 9: The lock system of any of clauses 1 through 8, wherein: the first aperture and the lock mechanism define a void, and in the assembled configuration, the baffle blocks the void.

Clause 10: The lock system of any of clauses 1 through 9, wherein, in the assembled configuration, the baffle floats between the cover and the lock assembly.

Clause 11: A lock system comprising: a lock assembly including a lock mechanism; a cover including a first opening configured to receive the lock mechanism; and a baffle including a base and at least one leg, the base including a first surface, a second surface, and a second opening smaller than the first opening and extending through the first surface and the second surface, the second opening configured to movably receive the lock mechanism, the at least one leg extending from the first surface, wherein, in an assembled configuration, the second surface is configured to engage the cover, and the at least one leg is configured to engage the lock assembly.

Clause 12: The lock system of clause 11, wherein the at least one leg includes a first leg and a second leg.

Clause 13: The lock system of clause 12, wherein the second opening is located between the first leg and the second leg.

Clause 14: The lock system of clause 13, wherein: the first leg extends from a first end of the base, and the second leg extends from a second end of the base.

Clause 15: The lock system of clause 14, wherein: the base is perpendicular to the first leg, and the first leg is parallel to the second leg.

Clause 16: The lock system of clause 15, wherein a cross-section of the baffle defines a U-shape.

Clause 17: The lock system of any of clauses 11 through 16, wherein the second opening is located at a center point of the base.

Clause 18: The lock system of any of clauses 11 through 17, wherein the second opening is a circle.

Clause 19: The lock system of any of clauses 11 through 18, wherein: the first opening and the lock mechanism define a void, and in the assembled configuration, the baffle blocks the void.

Clause 20: The lock system of any of clauses 11 through 19, wherein, in the assembled configuration, the baffle floats in between the cover and the lock assembly.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A lock system comprising:
a cover including a first aperture defining a first cross-sectional dimension;
a lock assembly including a lock mechanism defining a second cross-sectional dimension; and
a baffle including a base and at least one leg, the base including a second aperture defining a third cross-sectional dimension smaller than the first cross-sectional dimension and larger than the second cross-sectional dimension,
wherein, in an assembled configuration, the base engages the cover, the at least one leg engages the lock assembly, and the lock mechanism is disposed within the first aperture and the second aperture.

2. The lock system of claim 1, wherein the at least one leg includes a first leg engaging the lock assembly and a second leg engaging the lock assembly.

3. The lock system of claim 2, wherein the second aperture is located between the first leg and the second leg.

4. The lock system of claim 3, wherein:
the first leg extends from a first end of the base, and
the second leg extends from a second end of the base.

5. The lock system of claim 4, wherein:
the base is perpendicular to the first leg, and
the first leg is parallel to the second leg.

6. The lock system of claim 5, wherein a cross-section of the baffle defines a U-shape.

7. The lock system of claim 1, wherein the second aperture is located at a center of the base.

8. The lock system of claim 1, wherein the second aperture defines a circle.

9. The lock system of claim 1, wherein:
the first aperture and the lock mechanism define a void, and
in the assembled configuration, the baffle blocks the void.

10. The lock system of claim 1, wherein, in the assembled configuration, the baffle floats between the cover and the lock assembly.

11. A lock system comprising:
a lock assembly including a lock mechanism;
a cover including a first opening configured to receive the lock mechanism; and
a baffle including a base and at least one leg, the base including a first surface, a second surface, and a second opening smaller than the first opening and extending through the first surface and the second surface, the second opening configured to movably receive the lock mechanism, the at least one leg extending from the first surface,
wherein, in an assembled configuration, the second surface is configured to engage the cover, and the at least one leg is configured to engage the lock assembly.

12. The lock system of claim 11, wherein the at least one leg includes a first leg and a second leg.

13. The lock system of claim 12, wherein the second opening is located between the first leg and the second leg.

14. The lock system of claim 13, wherein:
the first leg extends from a first end of the base, and
the second leg extends from a second end of the base.

15. The lock system of claim 14, wherein:
the base is perpendicular to the first leg, and
the first leg is parallel to the second leg.

16. The lock system of claim 15, wherein a cross-section of the baffle defines a U-shape.

17. The lock system of claim 11, wherein the second opening is located at a center point of the base.

18. The lock system of claim 11, wherein the second opening is a circle.

19. The lock system of claim 11, wherein:
the first opening and the lock mechanism define a void, and
in the assembled configuration, the baffle blocks the void.

20. The lock system of claim 11, wherein, in the assembled configuration, the baffle floats in between the cover and the lock assembly.
